(19) United States
(12) Patent Application Publication
(10) Pub. No.: US 2013/0029020 A1
(43) Pub. Date: Jan. 31, 2013

(54) METHOD AND AN APPARATUS FOR RECOVERING ENERGY IN HOT-FILL OF A LIQUID FOOD PRODUCT

(71) Applicant: Bodo Rewolle, Limhamn (SE)

(72) Inventor: Bodo Rewolle, Limhamn (SE)

(73) Assignee: TETRA LAVAL HOLDINGS & FINANCE S.A., Pully (CH)

(21) Appl. No.: 13/640,894

(22) PCT Filed: Mar. 30, 2011
(86) PCT No.: PCT/SE11/00059

§ 371 Date: Oct. 12, 2012

(30) Foreign Application Priority Data
Apr. 13, 2010 (SE) 1000367-1

(51) Int. Cl. B65B 55/14; A23L 3/16; A23L 2/46

(52) U.S. Cl. 426/407; 99/483

(57) ABSTRACT

The invention relates to a method and an apparatus for recovering energy in the hot-fill of a liquid food product. The product is heat treated in a first section (5) of a heat exchanger (4) and is held at this temperature during a certain time interval. The temperature of the product is adapted to the hot-fill temperature in a second section (8) of the heat exchanger (4).

The product is hot-filled in a filling machine (10) and the product surplus from the filling machine (10) is cooled in a fourth section (15) of the heat exchanger (4). The product surplus is finally cooled in a third section (12) of the heat exchanger (4) and recycled to production.

### TECHNICAL FIELD

The present invention relates to a method of recovering energy in hot-fill of a liquid food product, the method comprising the steps that the product, in a heat exchanger, is heat treated and held at this temperature during a given predetermined interval of time, that the temperature of the product is reduced to the hot-fill temperature and, at this temperature, is filled into consumer packages in a filling machine, and that the surplus from the filling machine is cooled and recycled to production.

The present invention also relates to an apparatus for recovering energy in hot-fill of a liquid food product, the apparatus comprising a heat exchanger with a first section for heating of product, a second section for adapting the temperature of the product to the hot-fill temperature, and a third section in which the surplus from a filling machine is finally cooled, the apparatus also including a holding cell as well as requisite conduits.

BACKGROUND ART

So-called hot-fill of liquid foods is a common method, principally used as regards acidic products such as fruit juices, nectar or other types of soft drinks. The pasteurized product is then filled at a temperature of 80-90° C. direct into consumer packages.

The background to hot-fill is to be found in the preserving or canning industry and is a more economical alternative than sterile filling lines, Capital investments costs for a hot-fill plant are considerably lower than for sterile plants and require fewer specific actions to be able to fill a product of long shelf-life, Hot-fill, in combination with acidic products, realises a ready-packed product which may be compared with sterile products and which has a shelf-life of 6-12 months.

In all filling of liquid products in modern filling machines, a certain constant pressure of the product into the filling machine is necessary. This gives rise to a certain surplus which returns to production. As regards filling at low temperatures, this does not entail any losses of enemy. But when the product is to be hot-filled, this implies that the surplus product must be cooled before it can return to production. If the surplus of product in hot-fill is 5-30%, this entails that a not inconsiderable volume of thermal energy must be lost by cooling.

### OBJECTS OF THE INVENTION

One object of the present invention is to realise a method and an apparatus which permit recovering thermal energy from the surplus of product and returning the energy to production.

A further object of the present invention is to reduce production costs in hot-. fill of a liquid food product.

Yet a further object of the present invention is that the apparatus according to the present invention gives a rapid payback despite increased capital investment costs.

### SOLUTION

These and other objects have been attained according to the present invention in that the method of the type described by way of introduction has been given the characterising feature that the product surplus from the filling machine is cooled in an extra step so that the thermal energy from the product surplus is recycled to production.

These and other object have further been attained in that an apparatus of the type described by way of introduction has been given the characterising feature that the heat exchanger includes a fourth section in which the surplus of product from the filling machine is cooled so that the thermal energy from the product surplus is recycled to production before the product surplus is finally cooled.

Preferred embodiments of the present invention have further been given the characterising features as set forth in the appended subelaims.

### BRIEF DESCRIPTION OF THE ACCOMPANYING DRAWINGS

Preferred embodiments of the present invention will now be described in greater detail hereinbelow, with reference to the accompanying Drawings. In the accompanying Drawings:

FIG. 1 shows, in the form of a flow diagram, a. conventional hot-fill plant; and

FIG. 2 shows, in the form of a flow diagram, a hot-fill plant according to the present invention.

The Drawings show only those details essential to an understanding of the present invention.

### DESCRIPTION OF PREFERRED EMBODIMENTS

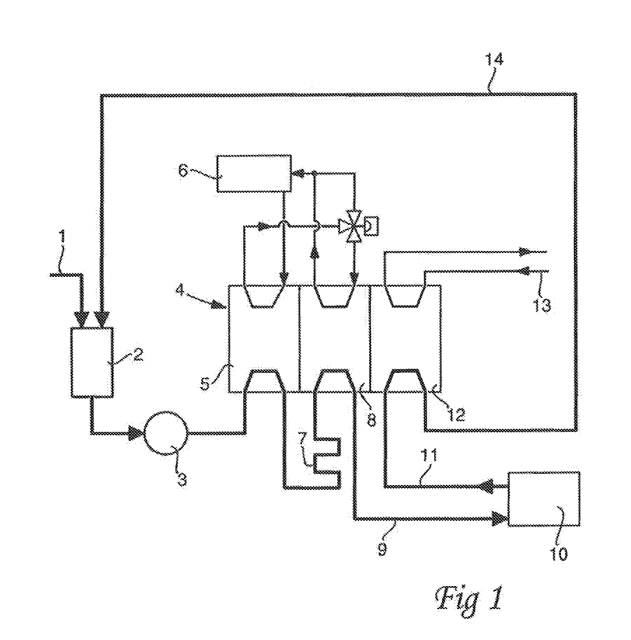

FIG. 1 shows a hot-fill plant according to the state of the art. Product enters the plant through a conduit 1 and is accumulated temporarily in a buffer tank 2 or an intermediate storage tank.

The product is preferably an acidic product, such as fruit or berry juice, nectar or so-called soft drinks. The term acidic product is taken to signify a product which has a pH of below 4.6. However, other products possessing a higher pH, such as juice and milk mixtures or flavoured teas, may also occur in respect of hot-fill.

The product which is normally at a temperature of approx. 2.5° C., is pumped by means of a centrifugal pump 3 further to a heat exchanger 4. The heat exchanger 4 is preferably a plate heat exchanger, but other types of heat exchangers may also occur.

In a first section 5 of the heat exchanger 4, the product is heated to pasteurization temperature, which, for acidic products, is 95-98° C. For products with a higher pH, higher temperatures are required. Heating takes place using hot water or steam from a central hot water supply 6, or alternatively a steam source.

In order for the product to be pasteurized, it is necessary that the product be held at pasteurization temperature for a given period of time, normally 15-30 seconds, depending upon product and pasteurization temperature. The product is held at pasteurization temperature in a holding cell 7. The holding cell 7 may consist of a pipe loop or alternatively a straight pipe of a predetermined length.

In a second section 8 of the heat exchanger 4, the temperature of the product is reduced to hot-fill temperature which is normally 80-95° C., preferably 85-90° C. The temperature is reduced in that the cooled hot water from the first section 5 is caused to pass the second section 8 before the cooled hot water is led back to the central hot water supply 6.

In the conduit 9, the hot product is supplied to a filling machine 10, where the product is filled into consumer packages. Since modern filling machines 10 require a certain constant pressure of the product into the filling machine 10, a certain product surplus will be obtained at the filling machine 10,

The product surplus may vary between 5 and 30%, but a normal surplus is calculated to be approx. 10%. When a cooled product is filled into packages, this constitutes no problem when the product is returned to production. But when a product is hot-filled, the surplus must be cooled down before the product surplus returns to production. As is shown in FIG. 1, the surplus which departs from the tilling machine 10 in the conduit 11 is normally cooled in a third section 12 of the heat exchanger 4. The cooling is put into effect using cold water or cooling tower water which enters into the third section 12 of the heat exchanger 4 through the conduit 13, The product is cooled in this third section 12 to a temperature of approx. 40° C. The cooled product is returned in the conduit 14 to production and the buffer tank 2.

Given that it is necessary to cool down the product surplus before it returns to production, the thermal energy which the product surplus contains is lost and more hot water or alternatively steam and cooling water are consumed in production.

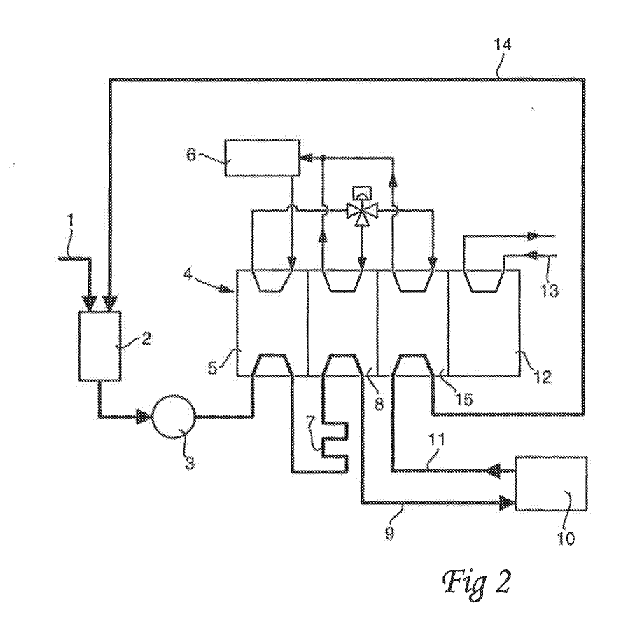

FIG. 2 shows a plant according to the present invention where it is possible to recover and recycle the thermal energy of the product surplus. Product enters into the plant through a conduit 1 and is accumulated temporarily in a buffer tank 2 or an intermediate storage tank.

The product is preferably an acidic product, such as fruit or berry juice, nectar or so-called soft drinks. The term acidic product is taken to signify a product which has a pH of below 4.6. However, other products with a higher pH, such as juice and milk mixtures or flavoured teas may also occur as regards hot-fill.

The product which is normally at a temperature of approx, 25° C. is pumped by means of centrifugal pump 3 further to a heat exchanger 4. The heat exchanger 4 is preferably a plate heat exchanger, but other types of heat exchangers may also occur.

In a first section 5 of the heat exchanger 4, the product is heated to pasteurization temperature, which for acidic products is 95-98° C. For products with a higher pH, higher temperatures are required. The heating takes place using hot water or steam from a central hot water supply 6, or alternatively a steam source.

In order for the product to be pasteurized, it is necessary that the product be held at pasteurization temperature for a given period of time, normally 15-30 seconds, depending upon product and pasteurization temperature. The product is held at the pasteurization temperature in a holding cell 7. The holding cell 7 may consist of a pipe loop or alternatively a straight pipe of a predetermined length.

In a second section 8 of the heat exchanger 4, the temperature of the product is reduced to hot-fill temperature, which is normally 80-95° C., preferably 85-90° C.

The temperature is reduced in that the cooled hot water from the first section 5 is caused to pass the second section before the cooled hot water is returned to the central hot water supply 6.

In the conduit 9, the hot product is led to a filling machine 10, where the product is filled into consumer packages. Since modern filling machines 10 require a certain constant pressure of the product into the filling machine 10, a certain product surplus will be obtained at the filling machine 10,

The product surplus may vary between 5 and 30%, but a normal surplus is calculated to be approx. 10%. When a cooled product is filled, this constitutes no problem when the product is returned to production. But when a product is hot-filled, the surplus must be cooled before the product surplus returns to production.

The product surplus from the filling machine 10 is led to a fourth section 15 of the heat exchanger 4. The cooled hot water from the first section 5 and the second section 8 is caused to pass through the fourth section 15 of the heat exchanger 4 before the cooled hot water is recycled back to the central hot water supply 6.

In this fourth section 15 of the heat exchanger 4, the product surplus is cooled down to a temperature of 38-43° C., preferably 40-42° C. From the fourth section 15 of the heat exchanger 4, the product is led to the third section 12 of the heat exchanger 4 and the product surplus is cooled by means of cooling water or cooling tower water which enters into the third section 12 of the heat exchanger 4 through the conduit 13. The product is cooled in this third section 12 to a temperature of approx. 35° C. The cooled product returns in the conduit 14 to production and to the buffer tank 2.

Despite the capital investment which a fourth section 15 of the heat exchanger 4 would involve, calculations show that the reduction in consumption of hot water, or alternatively steam and cooling water, demonstrating that this investment gives a rapid pay-back, The saving also involves a reduced stress on the environment.

As will have been apparent from the foregoing description, the present invention realises a method and an apparatus for recovering the thermal energy which the product surplus in hot-fill contains and for recycling this energy to production. The method and the apparatus give reduced production costs and the capital investment costs for the apparatus may rapidly be discounted against reduced production costs.

What is claimed is:

1. A method of recovering energy in the hot-fill of a liquid food product. the method comprising the steps that the product, in a heat exchanger (4), is heat treated and held at this temperature during a given predetermined time interval, that the temperature of the product is reduced to hot-fill temperature and, at this temperature, is filled into consumer packages in a tilling machine (10), and that the surplus from the filling machine (10) is cooled and recycled to production, characterised in that the product surplus from the tilling machine (10) is, in an extra step, cooled so that the thermal energy from the product surplus is recycled to production.

2. The method as claimed in claim 1, characterised in that the hot-fill temperature is 80-95° C.

3. The method as claimed in claim 2, characterised in that the hot-fill temperature is 85-90° C.

4. An apparatus for recovering energy in hot-fill of a liquid food product, the apparatus comprising a heat exchanger (4) with a first section (5) for heating the product, a second section (8) for adapting the temperature of the product to the hot-fill temperature, and a third section (12) in which the surplus from a filling machine (10) is finally cooled, the apparatus also including a holding cell (7) as well as requisite conduits, characterised in that the heat exchanger (4) includes a fourth section (15) hi which the surplus of product from the filling machine (10) is cooled so that the thermal energy from the product surplus returns to production before the product surplus is finally cooled.

5. The apparatus as claimed in claim 4, characterised in that the product surplus in the fourth section (15) is cooled down to 38-43° C.; and that the product surplus in the third section (12) is finally cooled to approx. 35° C.

6. The apparatus as claimed in claim 5, characterised in that the product surplus in the fourth section (15) is cooled down to 40-42° C.
